(19) United States
(12) Patent Application Publication
(10) Pub. No.: US 2022/0018047 A1
(43) Pub. Date: Jan. 20, 2022

(54) MOISTURE TRANSFER YARN AND FABRIC

(71) Applicant: . BAYCHAR, Kittery Point, ME (US)

(72) Inventor: . BAYCHAR, Kittery Point, ME (US)

(21) Appl. No.: 17/443,514

(22) Filed: Jul. 27, 2021

Related U.S. Application Data
(63) Continuation of application No. 14/262,922, filed on Apr. 28, 2014, now abandoned.
(60) Provisional application No. 61/816,849, filed on Apr. 29, 2013.

(51) Int. Cl. D04B 1/16; B32B 5/02; B32B 5/26; D03D 1/00; D03D 15/44; D03D 15/47

(52) U.S. Cl. CPC D04B 1/16; B32B 5/026; B32B 5/024; B32B 5/26; D03D 1/00; D10B 2509/00; D03D 15/47; D10B 2331/04; D10B 2401/10; D10B 2501/00; D10B 2503/06; D03D 15/44

(57) ABSTRACT

A moisture transfer yarn blend and fabric containing a selected of engineered shaped, lobed, deep grooved, channeled, hollow, sheath-core, bi-component polymer silver fibers and bi-component polymer fibers, optionally blended with cylinder or round fibers or natural fibers or a combination. The engineered shaped, lobed, channeled and deep grooved polymer fibers have indentations along the longitudinal side of the fibers. The deep grooved fibers have four to eight deep indentations along the longitudinal side of the fibers and containing grooves in the deepest portion of the indentation.

### CROSS-REFERENCE

This application is a continuation application of U.S. application Ser. No. 14/262,922, filed Apr. 28, 2014, which claims priority from U.S. Provisional Application Ser. No. 61/816,849, filed Apr. 29, 2013.

### FIELD OF THE INVENTION

The present invention relates to technical, performance, moisture transfer, engineered polymer yarn blends for fabrics used in technical outwear, and casual apparel, footwear, accessories, bedding, mattresses toppers and medical applications.

### BACKGROUND OF THE INVENTION

Technical moisture transfer fabrics are known in the prior art. However, none of these provides the advantages provided by the present invention. In particular, the moisture management fabrics known in the prior art do not combine the selected group of engineered shaped polymer fibers or shaped polymer fibers and natural fibers to develop a preferred comfort range of yarns and fabrics that rapidly transfer moisture, have inherent antimicrobial properties and regulate temperature. Additionally, the known prior art does not teach the combination of engineered polymer fibers taught in the present invention. Several examples cited in this invention disclosure contain two polymer fibers, but fail to include the selected polymer shaped fiber blends or polymer and natural fiber blends described herein.

### SUMMARY OF THE INVENTION

A moisture transfer yarn blend and fabric containing a selected of engineered shaped, lobed, deep grooved, channeled, hollow, sheath-core, bi-component polymer silver fibers and bi-component polymer fibers, optionally blended with cylinder or round fibers or natural fibers or a combination. The engineered shaped, lobed, channeled and deep grooved polymer fibers have indentations along the longitudinal side of the fibers. The deep grooved fibers have four to eight deep indentations along the longitudinal side of the fibers and containing grooves in the deepest portion of the indentation.

The capillary action of the selected polymer fibers for yarn and fabrics is induced by the shaped of the polymer fibers, the polymer or polymers incorporated in the extruded fiber filaments or staple fiber, the space between the combined fibers incorporated in the yarn blend and fabric and the fabric construction. The capillary moisture movement action and thermal response may be increased or decreased with fiber additions or a removal of one or more fibers. The capillary action of the 4-8 deep grooved fibers is greater than shaped, channel or lobed fibers and in combination with one or more of the polymer fibers it rapidly transfers moisture away from the active lifestyle individual.

The present inventor has recognized the deficiencies in the moisture management textiles known in the prior art and has developed engineered polymer fiber combinations optionally combined with natural fibers for yarns and technical performance fabrics that are capable of overcoming the deficiencies. More specifically, the present invention discloses a carefully selected combination of engineered polymer fibers comprised of specific shaped, grooved, hollow, split, lobed, channeled, micro-fibers, bi-component and c-shaped fibers and silver or copper sheath fibers, silver fibers and cylinder or round fibers that in combination enable the rapidly transfer of moisture away from the individual providing improved comfort levels and “preferred comfort”.

The present invention develops numerous technical fiber blends carefully combined to secure the proper moisture transfer performance for the action sports performance category. The all-in-one yarn fiber blend and the fabrics containing the moisture transfer yarn fiber blend can be changed to address a multitude of performance levels. The front, back and side panels can perform at different MVT rates in a single garment or footwear article. The technical engineered polymer fiber blends can optionally be combined with natural fibers to increase thermal or cooling performance options and enhance comfort in the yarns or fabrics comprise of the fiber blends.

An object of the present invention is to provide an improved moisture transfer range of performance. The shaped fiber combinations contained in the yarns and fabrics rapidly removal moisture away from an individual's body and extend comfort and performance levels.

Another object of the present invention is to provide individuals involved in activities such as walking, hiking, running, climbing, snowboarding, skiing etc. with active wear or footwear products that extend comfort and performance levels. The selected engineered and shaped and deep grooved shaped and hollow polymer fiber blends may optional be combined with antimicrobial and natural fiber blends for yarns and fabrics that re-define moisture management and in the selected fiber combination enhance thermal and cooling technologies while increasing all performance levels. The engineered polymer fiber blend developed for yarns and fabrics may increase or decrease moisture movement and/or the thermal capacity or response during performance by adding addition fibers or removing fibers. The numerous fiber blends included in the yarns and fabrics provide “preferred comfort” in base layer products, outerwear for casual or technical apparel or footwear product. The antimicrobial, sheath core, silver polymer fibers included in the yarns and fabrics are extruded in an all-one process. The silver polymer cannot be removed from the polymer after the fiber is extruded The antimicrobial property will not wash out and the yarn and fabric is permanently antimicrobial.

The yarns and fabrics provide an all-in-one solution to moisture management and offer thermal and cooling performance in a yarn or fabric for apparel, accessories, footwear, bedding or the like.

Another object of the present invention is to provide a combination of yarns that can be economically be interchanged and combined into existing in market textiles and fabrics to enhance the moisture transfer, antimicrobial and heating and cooling properties and performance of the fabric in the market place. Additional phase change technology, air gel or sphere technology or nano-technology or a combination of these and other microsphere and nano particle technologies treatments may be applied to the yarn or included in the fiber or fiber blend to enhance the fabric and provide soil and water resistant properties or thermal capacity or response unknown in the prior art. Preferably, phase change microsphere technology is combined with nano-particle technology in a coating that develops a thermally regulating, water repellent and soil resistant fabric.

These and other objects, features, and advantages of the present invention will become more apparent in view of the following detailed description of the preferred embodiments in conjunction with the drawings.

### BRIEF DESCRIPTION OF THE DRAWINGS

FIG. 1 shows a Four Deep Groove (4DG) polymer fiber.

FIG. 2 shows hollow polymer fibers extruded with a hollow center.

FIG. 3 is an example of a shaped, lobed and channeled fiber.

FIG. 4 is an example of a bi-component fiber having one or more similar or dissimilar polymers in a core material.

FIG. 5 shows bi-component polymer fibers which have two different similar or dissimilar polymers blended into one fiber extruded from the same spinneret.

FIGS. 6A-6J show cross-sections of side by side bi-component fibers.

FIG. 7 shows a micro-fiber.

FIG. 8 shows a split fiber.

FIG. 9 shows shaped and cylinder or round fibers or two shaped fibers.

### DETAILED DESCRIPTION OF THE PREFERRED EMBODIMENTS

A detailed description of the preferred embodiments will be included in conjunction with the Figures. It should be understood that these embodiments are set forth for purposes of explanation only and are not to be interpreted as the only application of the present invention.

Although not specifically illustrated, all types of yarn and fabrics can be included selected fiber combinations according to the present invention. The invention develops a technical, moisture transfer fiber blends of two or more fibers for yarns and fabrics. The yarns develop fabrics and can easily be incorporated into all types of fabrics by one with ordinary skills in the art. The extruded, engineered, polymer fiber material utilized for the fiber development may be polyester, co-polyester, nylon, polypropylene or a combination of similar polymer types or two dissimilar polymers types or a combination of similar or dissimilar polymers types combined with a metal ion material to develop a sheath fiber or a combination of similar or dissimilar polymers with fibers. The similar or dissimilar polymer combinations may be extruded into shaped, lobed, channeled, deep grooved, hollow, split, micro and c-shaped fibers with one or more polymers in the fiber blend and the engineered shaped fibers may be combined with round or cylinder fibers. The engineered fiber blend invents two or more engineered polymer fibers for yarns and fabrics. The fiber yarn blends may combine fibers or eliminate fibers. The preferable 4-8 deep groove fiber may be combined with any single polymer fiber or a group of polymer fibers. Optionally, the 4-8 deep groove fiber and cylinder round fiber blend may contain further micro-split fibers, bi-component, crimped fibers or hollow and shaped fibers The shaped fibers and/or 4-8 Deep grooved shaped fibers with sheath core develops a preferable base yarn blend.

The polymer fibers may be zig-zag crimped, also called mechanical crimped. The two-dimensional zig-zag crimp fiber is obtained by passing a tow of extruded fibers through a narrow gap between two crimp rollers. Further examples of mechanical crimped fiber methods are referred to in EP 929700 A1 and U.S. Pat. No. 6,492,020 B1.

The fibers have a spiral crimp fiber. A spiral crimp, contrary to the two-dimensional zig-zag crimp, is a three-dimensional crimped fiber. A spiral crimp is developed by the methods described in U.S. Pat. Nos. 3,050,821, 3,118,012, EP 929700 A1 and U.S. Pat. No. 6,492,020 B1, which are hereby incorporated by reference.

Spiral crimped or self-crimping can be made by exploiting the morphology differences across the fiber either by utilizing the inherent morphology difference of two different polymers, or by creating a morphology difference in a homo-polymer by inducing additives or process manipulation. This can be achieved by the same methods used for polyester. The methods include:

Bi-component technologies displays two polymers such as side-by-side and the eccentric sheath-core technology develops fibers with a layer covering a core material which exploit the molecular weight and/or stereo-chemistry differences of each polymer and/or material included in the polymer blend. A similar effect can be achieved adding a homo-polymer to the fiber and manipulating the melt blown spinning fiber viscosity and temperature causing a differential in the orientation level across the fiber diameter. Additionally, cross linkers, polymer additives or branching agents can be incorporated to create a similar effect. The differential cooling and quenching of the solid, hollow and shaped fibers develops a differential in the orientation level across the fiber.

As the fiber is drawn, the orientation, and/or shrinkage differential between the two sides of the fiber is magnified, resulting in the formation of helical or spiral crimp once the tension is released and/or the fiber is heat set. Crimpled fiber may be added to any yarn blend in this invention.

This invention combines engineered, extruded polymer filament fibers or staple fibers or a combination of either or both of these polymer fibers with natural fibers for yarns and yarns combined in fabrics. The fiber combinations develop moisture transfer, antimicrobial yarns and fabric not known in prior art.

The selected engineered polymer fibers are described below.

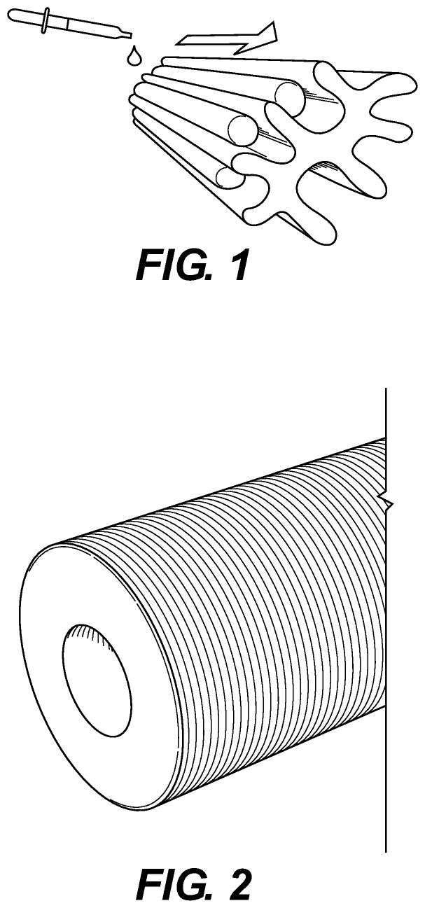

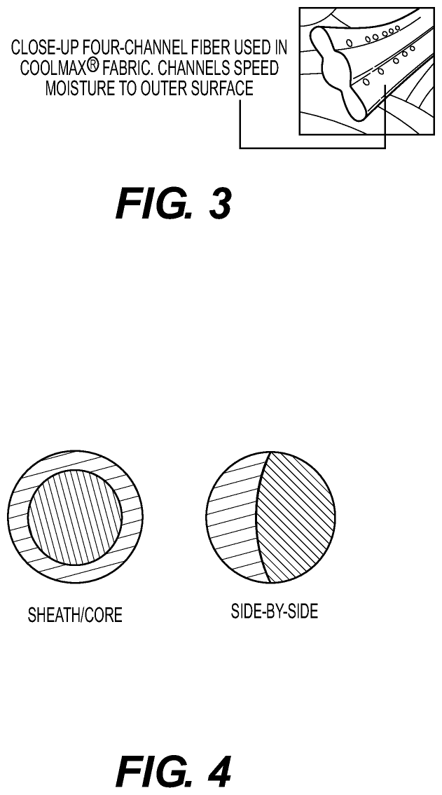

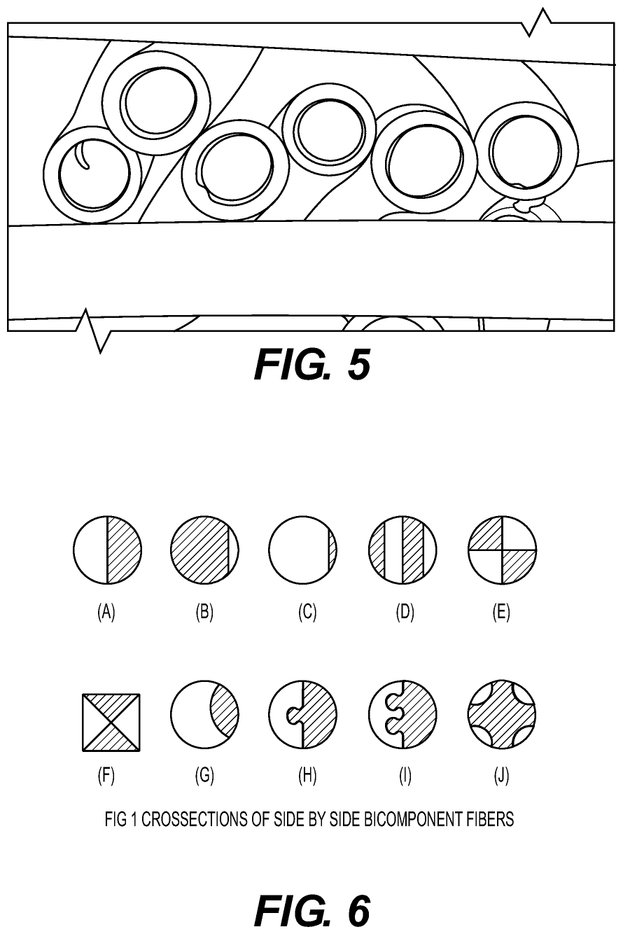

The fiber illustrated in FIG. 1 is a Four Deep Groove (4DG) polymer fiber. The illustrated polymer four to eight deep grooved shaped fiber is extruded into ameba-shape fibers with hills and deep grooved valleys which encourage moisture vapor to rapidly travel through the grooved in the valley floors. The fiber shape allows air and moisture vapor to rapidly pass over, around and through the valleys. In combinations with other such as hollow or channeled fibers, the 4-8 deep grooved polymer fibers rapidly remove and manage moisture. In some performance options, a ten to sixteen grooved fibers may be combined with the 4-8 deep grooved fibers in the yarn blend or the 4-8 deep grooved fibers may be replaced with the 10-16 grooved fiber in the yarn fiber blend to increase moisture management and develop a superior performance fabric. A 1 sixteen groove fiber is recently developed by Toray international textiles group. The shaped 16 grooved fiber is combined in the Toray products with round cylinder fibers. The moisture movement of the 16 grooved fiber has a large number of surface grooves spread out around the extruded fiber. The fiber, but in combination with the invented 4-deep groove fiber or blend the 16 fiber yarns blend moisture management is improved. The Baychar invented fiber blends for yarns and fabrics preferably includes the 4-8 deep groove fiber in the fiber blend for yarns, but the invented engineered fiber shaped blend is not limited to a 4-deep groove fiber blend. The shaped fibers in this invention can be improved and include two similar or dissimilar polymers developing a bi-component shaped fibers and or a metal material polymer sheath-core shaped fiber develop a moisture transfer, silver sheath-core shaped fiber. The preferably embodiment further invents shaped 4-8 deep groove silver sheath polymer fiber with one or more polymer core materials.

The deep grooved fiber may be polyester, nylon, acrylic, polypropylene or co-polymer or the like as a extruded filament yarn or staple fiber. Examples of the 4-8 deep grooved are referred to in U.S. Pat. Nos. 4,964,398 and 4,954,398, which are hereby incorporated by reference.

The fiber illustrated in FIG. 2 is a hollow polymer fibers extruded with a hollow center. The hollow fiber allows air and moisture to rapidly passes through the center of the fiber while enhancing the yarn and fabric thermal capacity and response in specific fiber combinations.

In combination with the 4-8 deep grooved and shaped fibers, the hollow fibers provide increased thermal and air movement.

The fiber illustrated in FIG. 3 is one example of a shaped, lobed and channeled fibers. The shaped fibers have numerous shapes. Currently, The most common are tri-lobed fibers with three channeled extending along the fiber length or four channels developed indentations along the longitudinal side of the fibers.

Similar to the deep grooved fibers, the shaped, lobed and channeled fibers transfer, moisture vapor along the fiber length and through the channels. The shaped channeled fibers and move moisture at a slow rate than the 4-8 grooved fibers, but in the preferable yarn blend combination with the 4-8 deep groove fibers, the shaped, lobed and channeled fibers develop an even distribution of moisture front the back in a fabric layer. Coolmax is an example of a 4-channeled lobed fiber.

This invention in one option develops a preferable replacement for Coolmax and combines channeled, shaped, 4-8 deep grooves fibers and silver sheath fibers. The Coolmax fabric is further enhanced with the sited invented moisture transfer yarns containing a 4-8 deep groove fiber and silver sheath core fibers. The Coolmax fibers are further enhanced by this invention with the addition of a silver material developing the Coolmax, shaped tri-lobed, bi-component polymer fiber into a silver sheath-core fiber.

The fiber illustrated in FIG. 4. Sheath-core fibers technology develops bi-component fibers comprised of one or more similar or dissimilar polymers in a core material. The sheath-core material can be two polymers or a polymer and silver or copper metal. The invented moisture transfer fiber blend preferably incorporates an antimicrobial and anti-fungus silver sheath-core polymer fiber with the 4-8 deep groove polymer fiber blend and incorporated the two fiber blend with one or more engineered shaped, hollow, split, micro, and/or bi-component fibers and optional natural fibers. The sheath-core fiber technology extrudes the filaments or staple fibers one process. An example of a sheath-core, antimicrobial, bi-component fiber invention is included and referred in U.S. Pat. Nos. 6,841,244 and 6,723,428 by Foss Manufacturing.

The fibers illustrated in FIGS. 5 and 6 are Bi-component polymer fibers which have two different similar or dissimilar polymers blended into one fiber extruded from the same spinneret.

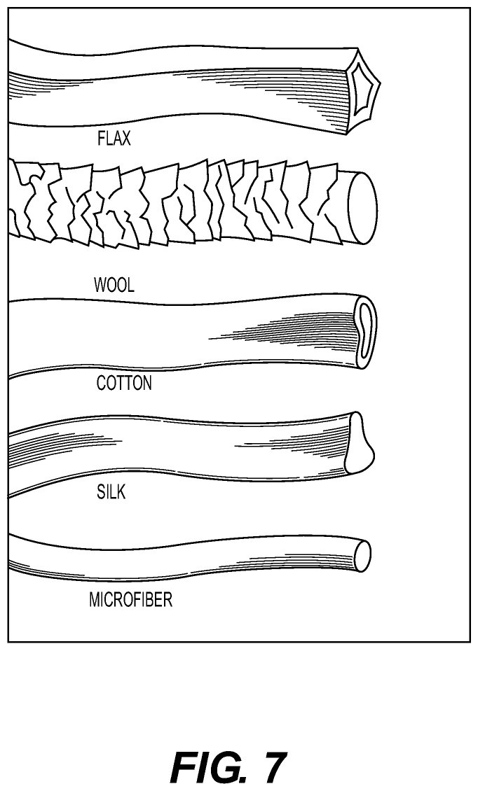

The fiber illustrated in FIG. 7 is a micro-fiber. Micro-fiber is an extremely fine synthetic fiber that enhanced wash ability, breathability, and water repellency. In combination with the 4-8 deep groove fiber and shaped fiber blends these fibers develop soft and durable light weight moisture transfer yarns and breathable fabrics. The fabrics may or may not be antimicrobial with the addition of the sheaf-core fiber and they may be treated with nano-technology for soil and water resistance. The light-weight moisture transfer fiber yarn combination containing shaped fibers and 4-8 deep groove fibers and micro-fibers developed light-weight, base layer products for cycling, running. action wear and extreme sports.

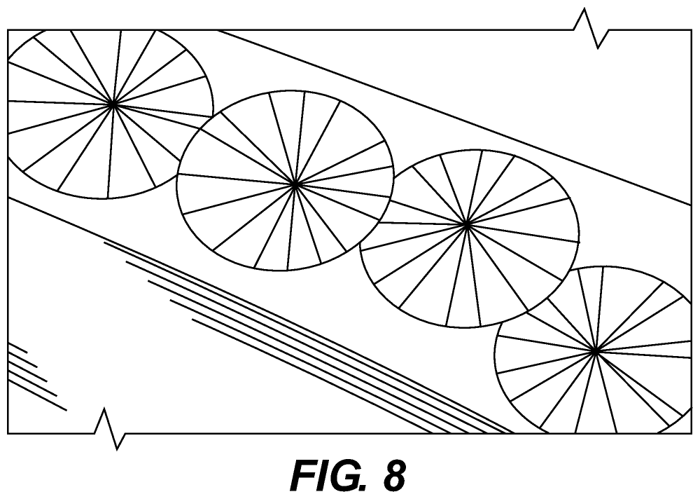

The fiber illustrated in FIG. 8 is a split fiber. Split fibers can be have two dissimilar polymers and may be 1-micro and up to 3 microns. The split fiber, 4-8 deep groove fiber combinations including hollow and silver sheath fibers develop action sports antimicrobial, base layers products with or without thermal options. The yarns and fabrics can be brushed to develop polar fleece products. This invention develops polar fleece products treated with a selected nano-technology treatment to prevent the collection of pet hair and lint on the surface of the fabrics while allow breathability and moisture vapor transfer.

An example of a splittable fiber is disclosed in U.S. Pat. No. 6,465,095. The shaped, 4-8 grooved, hollow, lobed and tri-lobed, channeled, bi-component, crimped, cylinder, split and sheath,-core polymer fiber blends optionally combined with natural fiber develop numerous performance options for moisture transfer yarns and fabrics. The U.S. Pat. No. 6,509,285 is hereby incorporated. The Yeh patent disclosure is limited to a combination of two fibers, round or cylinder fibers and channeled fibers or two channeled fibers. The moisture management in the 6509285 two fiber invention for fabrics is dramatically improved and further enhanced when combination the 4-8 deep groove fibers, and one or more of the selected bi-component fibers, shaped or lobed fibers, channeled fibers, hollow fibers and silver sheath polymer fibers into the yarn blend and fabric. One or more of the polymer fibers mentioned may be eliminated in select performance categories. One or more natural fibers such as wool, lyocell/Tencel or cotton or the like may be combined with the polymer fiber yarn blend containing the shaped and deep grooved polymer fiber blend for yarns and fabrics. Acrylic fibers may be added to any polymer fiber blend or yarn this invention. The fiber moisture transfer yarns blends can contain a combination of shaped, lobed, channeled and grooved fibers or these fibers with cylinder fibers.

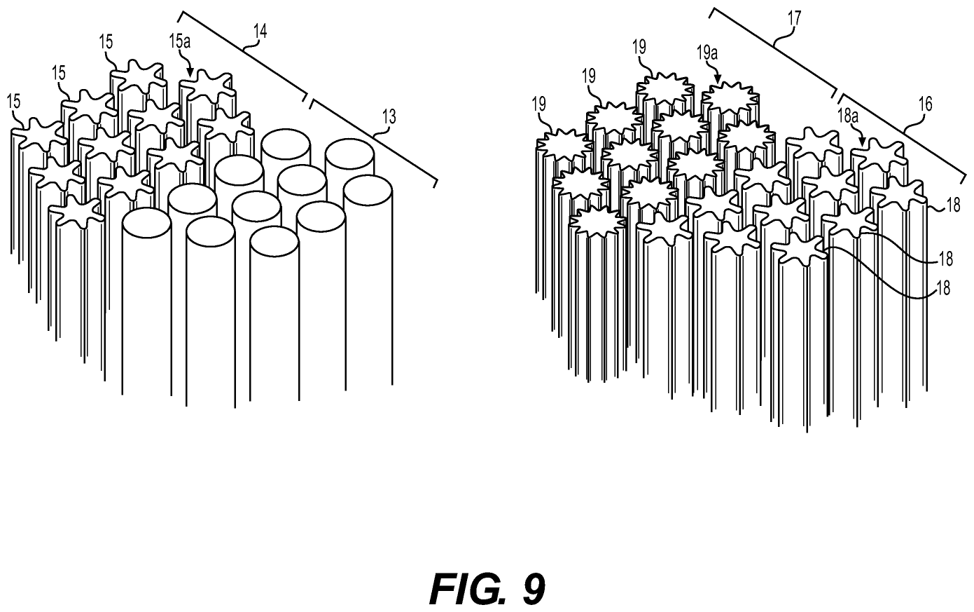

FIG. 9 is an example of shaped and cylinder or round fibers or two shaped fibers.

Alternatively, a group of selected natural fibers blends such as wool or lyocell/Tencel may be combined with any of the engineered polymer fibers blends mentioned and especially with micro fibers to develop a soft light-weight breathable fabric. The blend may contain polypropylene, polyester, Kelvar, Nylon, elastine or LYCRA® fibers or a combination of these fibers in the MVT yarn blend or fabrics.

Fabric construction enhances moisture transfer and in combination with the engineered, shaped polymer fiber selection regulates and manages the moisture management.

The single or double-sided knitted or woven fabric may be combined with one or more of the mentioned moisture management, engineered shaped fiber yarn blends. The double knitted or woven fabrics may contain a four to eight deep groove fiber or blend of one or more fibers the like on the face side or backside of the fabric both sides of the fabric. The invented 4-8 (4DG) deep groove fiber yarn blends containing the 4DG fiber, rapidly moves moisture away from the face of the fabric to the back of the fabric or double-knit or woven fabric. The mentioned double-knitted or woven fabric is developed in one process. The wickable face yarns containing the preferred fiber yarn blends developed performance blends for the selected base layer, apparel and footwear products. The preferable synthetic fiber blends spread out the moisture vapor and rapidly move it away from the individual. The double-sided knitted or woven fabric may combine shaped, grooved, sheath silver polymer and bi-component polymer fibers or silver fibers on either side or both sides. The four to eight deep grooved fiber, hollow, split, bi-component fibers comprised of two polymers, sheath polymer silver fibers or silver fibers or a combination of two or more of these polymer fibers develop exceptional yarn blends for the base layer fabrics and causal and technical apparel. The technical, engineered shaped, hollow and sheath-core fiber blends may be added to any existing yarn or fabrics. The moisture transfer, antimicrobial fiber yarn bends develop polar fleece base layer and active wear products.

Round or cylinder fibers and natural fibers may be added to the performance technical polymer fiber yarn blend and can be considered in a knitted fabric or double knitted or woven fabric construction. The yarns or fabric may be treated, water resistant DWR treatments, encapsulation technology, nano-technology, air gel technology and/or phase change technology. The treated technical fiber yarn blend may be included in a fabric. The selected engineered polymer shaped fiber yarn blends may be incorporated on either side of the double knitted or woven fabric or both sides of a double knitted or woven fabric and natural fibers maybe included in the yarn or a fabric construction or in double knitted or woven fabric on either side or both sides of the double knit or woven fabric construction.

The performance category elected combination of synthetic engineered shaped polymer fibers, or a combination of synthetic engineered polymer fibers and natural fibers, rapidly transfer and pulls the moisture away from the active individual. A preferable fabric waffle weave or knit construction enhances the technical yarns included in fabric or double knit or woven fabric construction allowing the air movement generated during performance to naturally spread the moisture vapor along and through the fiber filament or staple fiber yarns and fabric and transfers, ionizes and evaporation the moisture vapor in the fabric. The fiber blends and yarns are ideal for double-sided moisture transfer, knitted or woven fabric base layers products for running, cycling, hiking and active summer sports and winter hiking, skiing, snowboard climbing base layers. The winter sports base layers products may be polar fleece and include 4-deep groove fibers, hollow, split , micro and shaped fiber blends to enhance the moisture movement and thermal performance options.

The technical, engineer fiber blends develop yarns for use in socks, hats, gloves, helmet and sleeping bag liners and single layer or double knitted or woven fabrics for apparel, footwear linings, accessories, bedding and the like. The engineered shaped fiber yarn blends with or without natural fibers develop MVT, base layer fabrics, MVT fabrics for technical or causal apparel or footwear linings and a multitude of casual and technical performance activities and active and action sports categories. The MVT lining fabric provides exceptional performance for walking casual, running and hiking shoes, alpine, snowboard and ice boots or skates. The MVT fabric is recommended for technical apparel, soft-shell apparel, wind and water sports shell fabrics, stretch woven fabrics for technical, soft-shell products and for athletic and hiking shoes, alpine, climbing, snowboard and ice boot lining materials.

The technical shaped fiber yarn blends can develop fabrics for bedding, mattress covers and toppers and medical garments. The moisture transfer breathable yarns and fabrics may be treated with phase change materials that adjust and regulate temperature resolving over heating and cooling problems during sleep. The phase change materials technology or air gel technology or a combination improves and enhances the thermal release and cooling during sleep cycles. The Bedding Products similar to the active sports products are enhanced with increased moisture management breathability and thermal regulation.

Examples of the fiber blends for yarns and fabrics are suggested as below. The fabric blends may be applied to single layer knitted or woven or doubled knitted or woven fabric construction for applications in apparel, footwear, accessories or the like or the fabrics maybe incorporating into apparel, footwear accessory as lining materials or included in composite linings for apparel, footwear, accessories, sleeping bags or the like.

The amount of each sample fiber 4-8 deep groove fiber bi component, split, micro, hollow, sheaf core fibers and the like depends on the product the fabric and the performance level the products will be included in

Example of fabrics construction and blend are as follows;

1) A yarn blend or waffle knit or double knitted or woven fabric comprised of engineered polymer shaped fiber blend for yarn or fabrics containing a four to eight deep groove (4-8 DG) polyester fiber, shaped polyester or channeled fiber and hollow fibers and stretch fibers. One or more of the fibers in this option may be removed depending on the performance category.

2) A knitted or woven, moisture transfer yarn or fabric comprised of a technical, engineered polymer shaped fiber yarn blend containing a four to eight deep groove (4-8 DG) polyester fiber, shaped tri-lobed or 4 channel fiber, hollow fibers, and silver sheath-core polymer fibers. A second yarn blend optionally combined with the first yarn blend containing acrylic fibers and/or bi-component polymer fibers. Additionally, the single yarn blend or combined yarn blend may combine further with one or more natural fiber(s) such as wool, Tencel or the like. Stretch fibers may be added to this option in action sports categories. One or more of the fibers in this option may be removed depending on the performance category.

3) A knitted or woven, moisture transfer yarn blend for a fabric comprised of the technical, engineered polymer fiber yarn blend contains a four to eight deep groove (4-8 DG) polyester fiber, shaped fibers, silver sheath polymer fibers and acrylic fibers, bi component polymer fibers and natural fibers. Acrylic or bi-component polymer fibers may be removed from this option in some performance categories. Stretch fibers may be added to this option.

4) A knitted or woven moisture transfer fabric contains a technical, engineered polymer fiber yarn blend containing a four to eight deep groove (4-8 DG) polyester fiber, shaped and hollow polymer fibers, and wool or Tencel /lyocell fibers. Optionally, acrylic and/or bi-component fibers may be combined in the yarn blend or fabric. Stretch fibers may be added to this option.

5) A knitted or woven moisture transfer fabric contains a shaped polymer fibers, stretch Lycra spandex or elastine fiber, polyester and/or nylon fiber combined with grooved shaped 4-8 groove fibers for yarns incorporated into socks and single or double knitted and woven moisture transfer fabrics. The yarn blend(s) may be additional may further combine, bi-component fibers containing two or more polymers and silver or copper sheath core polymer fibers. This antimicrobial fiber blend for yarn and fabric may further include hollow, split or micro-fibers to enhance thermal options and moisture management options and the single or double layer woven or knitted fabric construction may remove one or more fibers for specified performance categories.

The 4-8 grooved, shaped, extruded polymer filament may be added to either layer of the double knitted fabric construction or both layers of the double knitted or woven fabric.

6) A double knit or woven fabric containing a yarn comprised of a technical, engineered polymer four to eight deep groove (4-8 DG) polyester shaped fiber and hollow polymer fibers one side and backed by one or more natural fiber yarn blends and polyester. The natural fiber may be cotton, wool silk, acetate, acrylics, Tencel, rayon, polyester, corn, bamboo, coconut, or a blend, The 4DG fiber and hollow fiber yarn blend may addition include acrylic fibers, shaped and sheath core fibers.

The natural fiber and polyester blend may include a shaped fibers or/and 4DG fibers. It recommended the natural fiber blend be treated with nano-technology for soil and water resistant properties

7) A double knit or woven fabric comprised of a technical, engineered polymer fiber face yarn blend containing a four to eight deep groove (4-8 DG) polyester fiber, shaped and hollow polymer face yarn blend backed with a yarn blend comprised of polyester, cotton, wool silk, acetate, acrylics, Lycra, Tencel, rayon, polyester, corn, kapok fibers or a blend of two or more of these fibers. Optionally, the natural fiber yarn blend may addition add polyester shaped fibers or 4DG fibers.

8) A double knit polar fleece fabric for base layer apparel containing a face yarn fiber blend comprised of an engineered polymer fiber yarn blend containing a four to eight deep groove (4-8 DG) polyester fiber, shaped and hollow polymer fibers backed with a polyester, cotton, wool silk, acetate, acrylics, Tencel, Lycra, rayon, polyester, corn, kapok fibers and a blend of 4-8 DG fibers, acrylic fibers and shaped polymer fibers.

Additionally, acrylic, a silver sheath core fiber or micro or split fiber may be combined with the 4-8 groove fiber blend.

9) A double knit for base layer apparel containing a face yarn comprised of a technical, engineered polymer fiber yarn blend containing four to eight deep groove (4-8 DG) fiber yarn blend backed with a polyester, cotton, wool silk, nylon, acetate, acrylics, Tencel, rayon, Lycra, polyester, corn, kapok fibers or a blend and shaped and or 4-8 groove fiber. Split fibers and micro-fibers may be combined with any yarn fiber blend or fabric containing the yarn fiber blends in this invention. The invented fiber blends for yarns are not limited to the listed combinations.

A number of industry marketed performance fabric may be improved by adding the invented technical moisture transfer fiber yarn blends. For example the following fabrics would develop improved performance options when incorporates the yarn fiber blend containing the 4-8 Deep groove fiber technical yarn blend. Any one of the suggested engineered fiber combinations can be combined into the existing sporting goods industry performance fabric. The moisture transfer shaped and 4-8 grooved yarns yarn increase moisture movement and the thermal capacity of the following fabrics. The rapidly movement of moisture and antimicrobial properties enhance performance and extend comfort.

The combination of 4-8 deep grooved fiber, silver sheath core fiber and hollow fibers or micro-fibers offer improved MVT transfer, antimicrobial and thermal options to the existing fabrics. A select group of fabrics is mentioned below. The invented fiber yarn blends and fiber combinations containing a 4-8 groove fiber are not limited to this group of fabrics and can be added to any knitted or woven fabric in combination with the technology. The 4 deep groove fiber yarn blend may be added in either fabric layer in a double knitted fabric or both layers.

There are numerous lining and apparel fabrics in the market place that can be improved with the addition of the suggested technical, moisture transfer fiber yarns blends. The following fabrics are examples of fabrics that could be improved with the multi-performance options offered by the invented technical yarn blend.

A polyester fabric with waffle weave construction (such as that manufactured by Toray combined with 4-8 groove fibers manufactured by Fit. The suggested 4-8 deep grooved and shaped polyester fiber and cylinder and/or shaped or bi-component, polymer polyester blend is invented for base layers and single layer apparel by Baychar. The combination of a FIELDSENSOR polyester products and a 4-8 deep groove fiber is preferable in some performance. The yarn blend may further combine silver sheath core fibers or silver fibers for antimicrobial properties.

A FIELDSENSOR polyester waffle weave knitted fabric such as that manufactured by Toray combined with 4-8 groove fibers, acrylic fibers and shaped fibers This blend is combination is invented for base layers.

A FIELDSENSOR polyester with waffle weave knit construction such as that manufactured by Toray combined with 4-8 groove fibers, bi-component polymer fibers, shaped and hollow fibers.

A FIELDSENSOR polyester knitted fabric with waffle weave or knit construction such as that manufactured by Toray combine sheath core polymer fibers or silver fibers.

A FIELDSENSOR polyester with waffle weave construction such as that manufactured by Toray combined with 4-8 groove fibers, bi-component polymer fibers silver sheath polymer fibers and shaped and hollow fibers.

A fabric containing a hydrophilic nylon yarn, combined with an anti-microbial sheath silver polymer fiber, 4-8 grooved polyester, and shaped polyester fiber.

A fabric containing a hydrophilic nylon, polypropylene or polyester and Lycra or spandex combined with an anti-microbial sheath silver polymer fiber, 4-8 grooved polyester, bi-component polymer fibers made of more than one polymer and shaped polyester. Optionally, any yarn fiber blend or fabric may include split and micro-fibers.

A fabric containing a hydrophilic polyester or nylon blend, anti-microbial, sheath, silver polymer fiber, 4-8 grooved polyester, nylon, wool and shaped polyester.

The POLARTEC SERIES 100 or 200 and POLARTEC POWERSTRETCH fabric by Polartec including a yarn containing a 4-8 deep groove fibers and a silver sheath polymer fibers. This fabric is also may include sheath core, anti-microbial, silver polymer fibers.

A POLARTEC SERIES 100 or 200 and POLARTEC POWERSTRETCH fabric including a yarn containing 4-8 groove fibers, hollow fibers and natural wool or Tencel/lyocell fibers or a blend of both natural fibers. This fabric may optional add silver sheath polymer fibers and acrylic fibers. This fabric is anti-microbial and thermal when the additional fibers are included.

Chemical and naturally ionized synthetic fabrics and fibers such as (MICROSAFE ACETATE, MICROSUPREME ACRYLIC CYSTAR, BIOFRESH and the like manufactured by Celanese Acetate, Sterling Performance Fabrics combined can improved with the addition of the moisture transfer yarn blends containing 4-8 groove fibers shaped fibers and hollow fiber.

A MICROSUPREME HIGH TECH ACRYLIC FABRIC by Sterling Performance Fabrics combined with a yarn containing 4-8 deep groove fibers, shaped fibers and hollow fibers.

ACRILLIAN or DURASPUN acrylics performance fabrics by Monsanto or blends of acrylics and polyester by Glenoit, or the like combined with 4-8 deep groove fibers and shaped polymer or/and hollow fibers.

A TEFLON or FREELON fiber blend of Friction Free Technology and other polyester and nylon fabric by Concept III combined with 4-8 groove fibers and shaped polymer or/and hollow fibers and silver sheath fibers.

Polartec polyester fleeced knitted fabric for base layers are improved when including the moisture transfer, shaped fiber yarn blend including, 4-8 deep grooved fibers, silver sheath fibers and natural fibers. The polar fleece blend may further include acrylic, cotton and wool for fleeced fabrics. It is understand that one or more fibers can be removed for a blend and that any fabric may add stretch fiber to the yarn blend for performance options can be removed.

The following fabrics may include the moisture transfer, yarn blend containing the invented 4-8 deep groove fiber, shaped and hollow fibers, bi-component and silver sheaf fibers yarn.

Corn fabrics or corn and cotton fibers with wool by Draper Knitting.

Cotton, acrylic or cotton, acrylic and polyester and 4-8 deep groove fibers by Concept.

KWILL fleece or DRI-RELEASE by Concept III.

K-WICK by Kronfli Spundale Mills.

MICROLANA MICROFABRIC by Glenoit.

MICROSUPREME HIGH TECH ACRYLIC by Sterling.

NANO-DRY by Burlington Fabrics or a blend of cotton and synthetics with NANO-Dry.

DYERTECH by Dyersburg.

DRYLINE by Milliken, a hydrophobic polyester and LYCRA®.

SWEET a polyester fabric by Tapetex.

Polyester and polypropylene fabric blend by Coville, including COMFORTREL. Also preferred are moisture transfer knits by Coville and blends of cotton and polyester and/or polypropylene, preferably HIGHLANDER-PLUS or POLYGON STRETCH.

Cross-dye POWER DRY and SMART FIBER fabrics by Wellman.

MICROMOVE by Burlington.

Polyester fabrics and blends by Kronfli.

M.C.S. with NANO DRY.

Schoeller DRY SKIN

,Hua feng textile fabrics

NAM-LION textiles

Cotton blend encapsulated;

Cotton denim or Chino encapsulated;

Cotton denim or Chino waterproof breathable membrane;

2/3 ply Supplex encapsulated;

2/3 ply Supplex waterproof breathable membrane;

6-ply Taslan encapsulated/waterproof breathable membrane;

Tudor by Travis encapsulated/waterproof breathable membrane;

Mojave/Twister by Travis encapsulated/waterproof breathable membrane;

Cordura encapsulated/waterproof breathable membrane;

Micro-Technical II sanded or Micro-Technical III Sanded by Brookwood encapsulated or membrane;

Citation Sanded or Jet-Laund by Brookwood encapsulated or breathable membrane;

Encapsulated Supplex by Toray;

Dermizax fabrics by Toray;

Entrant Gil by Toray;

Super-microft distributed by Teijin Shojin or ASF;

Gymstar Plus by Unitika;

Tuflex-HR by Unitika;

Schoeller Dryskin;

Schoeller encapsulated fabrics;

Schoeller Dynamic Extreme;

Schoeller Keprotec;

Schoeller Dynatec;

Schoeller stretch woven fabric

Schoeller Keprotec with Inox;

Schoeller NanoSphere fabrics

Schoeller WB 400 fabrics

Schoeller Kevlar, Cordura or composites with foam, nonwovens or both and PCMs;

Nam Liong, Toray, Teijin Shojin exterior shell performance fabrics and materials;

Micro-polyester fabrics distributed by Teijin Shojin;

Structurally knitted acrylic wool, with or without encapsulation (made by Toray), distributed by Teijin Shojin or ASF Group, Kyodo Sangyo Co. Ltd. (a structurally knitted fabric that repels water);

Vinyl materials with a nonwoven backing and plastics fabrics, by Tessile Florentina, Baikfan, or Teijin Shojin, these groups include Errebi, 101659-01669-01676-1271, 57006-800, and 43005-870;

Somatex, which is a neoprene type of material that is breathable;

Darlexx, which is a LYCRA® type of material and is to be used in the underarm portions of certain apparel;

Kolon HIPAN-Coolskin;

GoreTex soft shell composites and fabric;

Schoeller PCM composite constructed of exterior shell fabric with or without Nano-Technology, PCM foam and a knitted or nonwoven top sheet, or Schoeller exterior shell fabrics, foam with or without PCM and a nonwoven top sheet with PCM Technology;

Kolon HIPAN-THERMOSKIN or HIPAN-CLASSIC;

Hipora waterproof breathable fabric by Kolon;

Ripstop Hardline fabric; and

Wool and wool blends which include one or more of the following: acrylic, LYCRA®, polyester, cotton, lyocel and nylon. These fabrics are made of yarns and are hydrophobic. Wool and wool blends are provided by Euromotte, Inc. of Belgium, and/or Toray in Japan. These fabrics are pure wool, wool blends, or acrylics that are knitted with hydrophilic yarns so as to be waterproof. This is in effect an encapsulation process or treated with a Nano-technology.

Fiber and Fabric Treatments;

Furthermore, as mentioned the fabric or double knit or woven fabrics comprised of numerous engineered polymer fibers with or without natural fibers may be optionally treated with enhancement treatments such as thermally regulating phase change or air gel technology or soil and water resistant nano-technology or web encapsulation. The fabrics maybe to include with TRANSPOR DRY FIBER TECHNOLOGY, a wetting solution, DWR or the like to enhance the moisture vapor transfer (MVT) properties.

The technical yarns blend or and fabric may be treated with a chemical ionization, wicking solutions or a treatment such as COOLAN by KOLON TTA INC., or the like. Phase Change Technology thermal regulating technology (PCMs) may or may not be combined with, an ionization chemical treatment such as COOLON or the like to increase in moisture management and thermal options. A positive charge or negative charge may be added to the fabric for performance action sports and extreme apparel.

The shaped 4-8 deep groove polyester fiber, acrylic, polymer fibers, silver fibers, natural fibers can be combined with or PCMs technology, silica particles , air or gel spheres and anti-microbial sheath silver fibers or silver fibers.

This all-in-one moisture transfer fabrics are antimicrobial and thermally regulated by fiber content. Silica, air micro-spheres, PCM Technology, air spheres, Nano-Technology or air gel technology spheres by ASPEN or the like may be added to further enhance thermal comfort and performance. ASPEN air gels and Nano-Technology can be added to any fiber or yarn blend or fabric The shaped and grooved fibers may be encapsulated by Nectex, Toray, Kolon or the like or is knitted-wovens treated to repel water or if the NANOSPHERE Technology has been added to waterproof the exterior shell in layer 40.

A number of patents have been issued to Triangle Research & Development Corp. disclosing details related to the processes now being. For example, U.S. Pat. Nos. 4,756,958 and 5,366,801 are directed to fibers and fabrics with reversible enhanced thermal properties respectively. The disclosures of these two patents are hereby incorporated by reference. Other patents assigned to Triangle Research and Development Corp. that are related by subject matter and have overlapping inventorship, include U.S. Pat. Nos. 5,415,222, 5,290,904, and 5,244,356. These patents are also hereby incorporated by reference.

A coating with phase change microspheres and air gel or air spheres or the like may be added to the coating and included in the fabric or one of the layers in the fabric composite. The fibers and fabric can be optionally treated with a chemical ionization, an electrically charged solution to increase the MVT performance levels.

Exterior shell fabric can be waterproofed by membranes, encapsulation, film, wrapped fibers, internal webs and/or Nano-Technology. Molecular Nano-Technology creates a chemical sleeve or framework around the fiber and enhances the selected performance criteria. The exterior fabrics or material may be soli resistant and waterproofed with the NANOSPHERE Technology. The inner lining material or fabric MVT characteristics can be enhanced by NANO-FRY by Burlington Fabrics or NANO-TEX. The chemically developed sleeve or framework is molecular and may be created out of silicates. Nano-Technology may be applied to the molecular structure of a fiber. Additionally, Nano-Technology can be applied along a fiber in Nano Channels. Nano Channels are created to control the flow of minuscule amounts of fluid. The channels have elliptical edges that permit fluid to flow freely along the fiber enhancing the MVT rates. A transparent substance of silicon, silicon dioxide or glass is heated and applied to the fibers. The Nano-Technology maybe thermally sprayed. Inframat Corporation has developed a patented process for thermal spray of nano-structured, by which the nano-particles can be reconstituted into spherical micron-sized granular, that can be thermally sprayed. The Nano-Technology can be thermally sprayed to any layer in this MVT system and especially to exterior shell layer. The NANOSPHERE technology is self-cleaning and soil and stain resistant. Incorporated by reference are patents by Inframat Corporation. Incorporated by reference is U.S. Pat. No. 5,004,643 further additional patents by Caldwell and Nectex patents on encapsulation fibers and fabric. The structurally moisture transfer 4 deep groove and shaped fiber yarn blends and knitted or woven fabric move moisture and are water resistant or proof. The structurally woven or knitted fabrics including the technical MVT shaped fiber blend preferably containing 4-8 deep groove and shaped fibers yarn blends do not require encapsulation or breathable membranes to waterproof the garment. The preferred shaped fiber blend containing silver sheath core polymer fibers shaped fibers, 4-8 groove fibers and hollow fibers. In some options the hollow fibers may be combined with a bi-component polymer fiber or split fiber or the hollow fibers are removed.

Another preferable moisture transfer fabric containing the 4-deep groove and shaped fiber is structurally knitted and includes acrylic or acrylic blends, which may be encapsulated and distributed by ASF and made by Toray, for example.

The technical fiber MVT, exterior, soft-shell fabric may be backed by a MVT flocked fiber blend containing the same or similar moisture transfer fiber shaped and four deep groove fiber blend . the woven or shell fabric may further include, Lycra, Nylon, Spandex or stretch fibers and antimicrobial sheath core fiber blend. The exterior, soft-shell fabric comprised of 4-8 deep groove fibers, shaped fibers and hollow fibers may further include silver fibers. The shaped, MVT fiber yarn blends combination for fabrics composite products are hereby referred to and trademarked Baychar®.

Examples as follows;

Numeral 1100 incorporates the MVT Baychar, technical, yarn blend containing the shaped and sheath core fibers develops a knit or woven fabric abutting a nonwoven material or the MVT THERMAL® or CHAMELEON® fabric and nonwoven composite and exterior shell fabric or material. The exterior shell fabric is optionally waterproofed by encapsulation, membrane or film technology, encapsulation technology, matrix or nano-technology or coating with or without phase change materials.

Numeral 1200 Numeral 1100 incorporates the MVT Baychar®, technical, yarn blend containing the shaped preferably 4-8 groove fiber and sheath silver fibers develops a knit or woven fabric abutting backed by a flocked fiber blend. This all-in-one soft shell apparel can optional contain the Baychar MVT blend in the flocked fibers.

Numeral 1300 incorporates the MVT Baychar, technical, yarn blend containing the shaped, bi component, and sheath core, silver bi-component fibers develops a knit or woven fabric backed with adhesive and MVT flock fiber lining. The composite fabric develops a superior performance apparel product. The all-in-one soft-shell fabric composite product may be waterproof and contain adhesives stretchable fiber and phase change coating.

Numeral 1400 incorporates the MVT Baychar, technical, yarn blend containing the shaped, bi component, and sheath silver bi-component fibers develops a knit or woven fabric abutting a nonwoven, MVT Thermal nonwoven or CHAMELEON phase change nonwoven composite or a PCM coated thermal nonwoven and an exterior, soft shell fabric. The exterior shell may be waterproofed.

Numeral 1500 incorporates the MVT Baychar, technical, yarn blend containing the shaped, bi component, and sheath silver bi-component fibers develops a knit or woven fabric backed with foam material. MVT THERMAL or nonwoven material and an exterior soft shell fabric. This exterior shell fabric may be waterproofed in some options.

The engineered shaped fibers and microfiber technology disclosed above is rapidly developing and changing and with the structural changes of the fiber the potential for improved performance of products performance apparel, provided that they are properly utilized as in the present invention. These new products are part of rapidly developing fabric technology. The present invention employs a combination of engineered shaped fibers fabrics, for knitted and woven fabrics that are optionally treated to have soil and water repellent fabrics. Such combinations increase the performance durability and breathability. The combined performance options allow the individual to utilize the yarn or fabric products in a multiple of cross-discipline activities and the combined performance options eliminate weight during performance.

While the present invention has been described above in connection with the preferred embodiments, one of ordinary skill in the art would be enabled by this disclosure to make various modifications to the disclosed embodiments and still be within the scope and spirit of the present invention as recited in the appended claims.

What is claimed:

1. A moisture transfer, breathable, antimicrobial thermal and cooling, knitted or woven fabric providing thermal and cooling adjustable temperature regulation for use in apparel, footwear, accessories or bedding wherein a portion of the moisture transfer knitted or woven fabric comprises spun yarns which comprise:
deep groove polyester shaped fibers or shaped channeled fibers;
antimicrobial sheath-core silver fibers; and
natural and synthetic thermal and cooling fibers.

2. The moisture transfer knitted or woven fabric according to claim 1, wherein the moisture transfer knitted or woven fabric comprises synthetic hollow fibers, wool fibers, silk fiber, lyocell fibers cotton fibers or a combination thereof.

3. The moisture transfer knitted or woven fabric according to claim 1, wherein the moisture transfer knitted or woven fabric comprises synthetic cylinder shaped nylon, polyester fibers, acrylic fibers or a blend thereof.

4. A moisture transfer knitted or woven fabric according to claim 3, wherein the moisture transfer knitted or woven fabric comprises shaped or cylinder nylon fibers, polyester fibers, acrylic fibers or a blend thereof with one or more natural fibers.

5. A moisture transfer knitted or woven fabric according to claim 1, wherein the moisture transfer knitted or woven fabric comprises shaped, grooved channeled fibers, channeled fibers, shaped polymer fibers or a blend thereof combined with natural fibers.

6. A moisture transfer knitted or woven fabric according to claim 2, wherein the moisture transfer knitted or woven fabric comprises shaped, grooved fibers or channeled, shaped polymer fibers or a blend thereof combined with two natural or synthetic fibers.

7. A moisture transfer knitted or woven fabric according to claim 1, wherein the moisture transfer knitted or woven fabric comprises a bi-component polymer fiber, acrylic fibers, split fibers or a blend thereof.

8. A moisture transfer knitted or woven fabric according to claim 2, wherein the moisture transfer knitted or woven fabric comprises a bi-component polymer fiber, acrylic fibers, split fibers, hollow fibers or a blend thereof.

9. A moisture transfer knitted or woven fabric according to claim 1, wherein the moisture transfer knitted or woven fabric comprises a bi-component polymer fiber and antimicrobial sheath core fiber and/or natural fibers.

10. A moisture transfer knitted or woven fabric according to claim 2, wherein the moisture transfer knitted or woven fabric comprises a microfiber and bi-component polymer fiber or a blend thereof.

11. A moisture transfer, breathable, antimicrobial knitted or woven fabric providing adjustable, dual temperature regulation for use in apparel, footwear, accessories or bedding comprised of spun yarns which comprise:
shaped, grooved, lobed and channeled polymer synthetic fibers;
antimicrobial fibers; and
natural and synthetic thermal or cooling fibers,
wherein the yarns provide increased breathability and adjustable thermal or cooling performance.

12. A moisture transfer knitted or woven fabric according to claim 11, wherein the yarns comprise shaped deep groove fibers, polyester shaped and channeled fibers and antimicrobial silver polymer fibers.

13. A moisture transfer knitted or woven fabric according to claim 12, wherein the yarns include antimicrobial silver polymer fiber, hollow fibers, acrylic fibers, cotton fibers, lyocell fibers, wool fibers, silk fibers, bamboo fibers or a blend thereof.

14. A moisture transfer knitted or woven fabric according to claim 12, wherein the yarns include hollow fibers and wool or cotton fibers.

15. A moisture transfer knitted or woven fabric according to claim 11, wherein the yarns include bi-component polymer fibers, hollow fibers, antimicrobial silver polymer fibers, bamboo fibers, flax fibers or a combination thereof.

16. A moisture transfer, breathable, antimicrobial thermal or cooling knitted or woven fabric providing thermal and cooling adjustable temperature regulation for use in apparel, footwear, accessories or bedding wherein a portion of the moisture transfer knitted or woven fabric comprises spun yarns which comprise:
deep groove polyester shaped fibers or shaped channeled fibers;
antimicrobial sheath-core silver fibers; and
natural or synthetic thermal and cooling fibers.

17. The moisture transfer knitted or woven fabric according to claim 16, wherein the moisture transfer knitted or woven fabric comprises synthetic hollow fibers, wool fibers, silk fibers, lyocell fibers, cotton fibers or a combination thereof.

18. The moisture transfer knitted or woven fabric according to claim 16, wherein the moisture transfer knitted or woven fabric comprises synthetic cylinder shaped nylon fibers, polyester fibers, acrylic fibers, polypropylene fibers, natural or a blend thereof.

19. A moisture transfer knitted or woven fabric according to claim 18, wherein the moisture transfer knitted or woven fabric comprises shaped or cylinder nylon fibers, polyester fibers, acrylic fibers, polypropylene fibers or a blend thereof with one or more natural fibers.

20. A moisture transfer knitted or woven fabric according to claim 16, wherein the moisture transfer knitted or woven fabric comprises shaped, grooved channeled fibers or channeled fibers, shaped polymer fibers or a blend thereof combined with natural fibers.
